(19) United States
(12) Patent Application Publication
(10) Pub. No.: US 2009/0204955 A1
(43) Pub. Date: Aug. 13, 2009

(54) SYSTEM AND METHOD FOR AUTOMATED DISTRIBUTION AND IMPLEMENTATION OF SECURITY FIXES

(76) Inventors: William Su, Riverside, CA (US); Hongfeng Wei, Cerritos, CA (US); Jianxin Wang, Trabuco Canyon, CA (US)

Correspondence Address: TUCKER ELLIS & WEST LLP, 1150 HUNTINGTON BUILDING, 925 EUCLID AVENUE, CLEVELAND, OH, 44115-1414, US

(21) Appl. No.: 12/027,453

(22) Filed: Feb. 7, 2008

(51) Int. Cl. G06F 9/44

(52) U.S. Cl. 717/168

(57) ABSTRACT

The subject application is directed to a system and method for automated distribution and implementation of security fixes. A text message is first received into data storage of a document processing device via a data network. Strings in the received text message are then parsed so as to isolate control data, which includes advisory data corresponding to the applicability of a security risk associated with a class of devices and remedy data corresponding to a solution to a vulnerability problem associated with vulnerability data. The advisory data is then tested for applicability to the device, and the remedy data is analyzed according to the advisory test. An alteration of the document processing device is then completed in accordance with the output of analysis. The acceptability of the alteration of the device is then verified, and an applied alteration of the device is undone based upon the verification output.

### BACKGROUND OF THE INVENTION

The subject application is directed generally to addressing fixes for problems in a plurality of a document processing devices. The subject application is particularly suited to prescreening of vulnerability risks and generation of text-based messages that are prepared and distributed to plural networked machines, and which messages dictate procedures to be taken to address such vulnerability risks.

Data processing devices are continually subjected to alteration to address unforeseen or newly arisen problems associated with an earlier, associated configuration. By way of example, newly discovered software flaws, hardware flaws, or security risks may merit changing of system parameters, upgrading of software, or patching of software.

Information relative to events, such as that noted above, may be gleaned by posted bulletins, electronic mail announcements, receipt of upgrades or patches, or notifications that such are available. An administrator or user who is concerned with one or relatively few devices may readily monitor such information and determine whether action is merited. The burden is substantially more difficult when one is responsible for many devices, such being the case when the document processing devices are associated with many networked document processing devices. Such document processing devices include printers, copiers, facsimile machines, electronic mail servers, document storage appliances or servers, as well as multi-function peripherals (MFPs) which perform two or more of such functions. In these instances, an administrator may be tasked with ascertaining whether newly discovered information is applicable to their devices. If so, in certain instances, only a portion of the devices may merit modification.

There is a substantial burden associated with determining which, if any, of a plurality of devices merit alteration in view of newly discovered information. It is difficult and time consuming to undertake ascertaining a procedure and implementing a procedure to alter devices for which such is merited.

### SUMMARY OF THE INVENTION

In accordance with one embodiment of the subject application, there is provided a system and method directed to addressing fixes for problems in a plurality of document processing devices.

Further, in accordance with one embodiment of the subject application, there is provided a system and method for prescreening of vulnerability risks and generation of text-based messages that are prepared and distributed to plural networked machines, and which messages dictate procedures to be taken to address such vulnerability risks.

Still further, in accordance with one embodiment of the subject application, there is provided a system for automated distribution and implementation of security fixes. The system comprises means adapted for receiving a text message into a data storage of a document processing device via an associated data network. The system also comprises parsing means adapted for parsing strings in a received text message so as to isolate control data, wherein control data includes advisory data corresponding to applicability of a security risk associated with a class of devices and remedy data corresponding to a solution to a vulnerability problem associated with the vulnerability data. The system further includes testing means adapted for testing advisory data for applicability to the document processing device and analyzing means adapted for analyzing the remedy data in accordance with an output of the testing means. The system also includes updating means adapted for completing an alteration of the document processing device in accordance with an output of the analyzing means and verification means adapted for verifying acceptability of an alteration of the document processing device in accordance with operation of the updating means. The system further comprises means adapted for undoing an applied alteration of the document processing device in accordance with an output of the verification means.

In another embodiment of the subject application, the system further comprises means adapted for receiving warning data associated with a risk associated with at least one of hardware and software associated with the class of devices. The system also comprises classification means adapted for testing received warning data relative to data associated with at least one of hardware and software associated with the class of devices and generating means adapted for generating fix data corresponding to a fix associated with the class of devices in accordance with received warning data. The system further comprises means adapted for selectively generating the text message in accordance with an output of the classification means and output means adapted for communicating generated fix data to a plurality of devices in the class of devices via the associated data network. Preferably, the output means includes means adapted for communicating generated fix data to a plurality of devices in accordance with a mailing list inclusive of address data associated with each of the plurality of devices in the class of devices.

In a further embodiment of the subject application, the system also comprises threshold means adapted for testing severity of warning data against at least one pre-selected threshold level. In such embodiment, the generating means includes means adapted for generating fix data upon a determination by the threshold means that the at least one pre-selected threshold level has been achieved.

In yet another embodiment of the subject application, the system also comprises means adapted for retrieving a software patch specified by the remedy data in accordance with an output of the analyzing means. In such embodiment, the updating means further includes means adapted for applying a retrieved software patch.

In still another embodiment of the subject application, the text message further includes timing data associated with a desired timing of an updating by the updating means. In this embodiment, the updating means is further adapted to commence alteration of the document processing device in accordance with received timing data.

Still further, in accordance with one embodiment of the subject application, there is provided a method for automated distribution and implementation of security fixes in accordance with the system as set forth above.

Still other advantages, aspects, and features of the subject application will become readily apparent to those skilled in the art from the following description, wherein there is shown and described a preferred embodiment of the subject application, simply by way of illustration of one of the modes best suited to carry out the subject application. As it will be realized, the subject application is capable of other different embodiments, and its several details are capable of modifications in various obvious aspects, all without departing from the scope of the subject application. Accordingly, the drawings and descriptions will be regarded as illustrative in nature and not as restrictive.

### BRIEF DESCRIPTION OF THE DRAWINGS

The subject application is described with reference to certain figures, including:

FIG. 1 is an overall diagram of a system for automated distribution and implementation of security fixes according to one embodiment of the subject application;

FIG. 2 is a block diagram illustrating controller hardware for use in the system for automated distribution and implementation of security fixes according to one embodiment of the subject application;

FIG. 3 is a functional diagram illustrating the controller for use in the system for automated distribution and implementation of security fixes according to one embodiment of the subject application;

FIG. 4 is a block diagram illustrating a workstation for use as an administrative device in the system for automated distribution and implementation of security fixes according to one embodiment of the subject application;

FIG. 5 is a flowchart illustrating a method for automated distribution and implementation of security fixes according to one embodiment of the subject application;

FIG. 6 is a flowchart illustrating a method for automated distribution and implementation of security fixes according to one embodiment of the subject application; and

FIG. 7 is a flowchart illustrating a method for automated distribution and implementation of security fixes according to one embodiment of the subject application.

### DETAILED DESCRIPTION OF THE PREFERRED EMBODIMENT

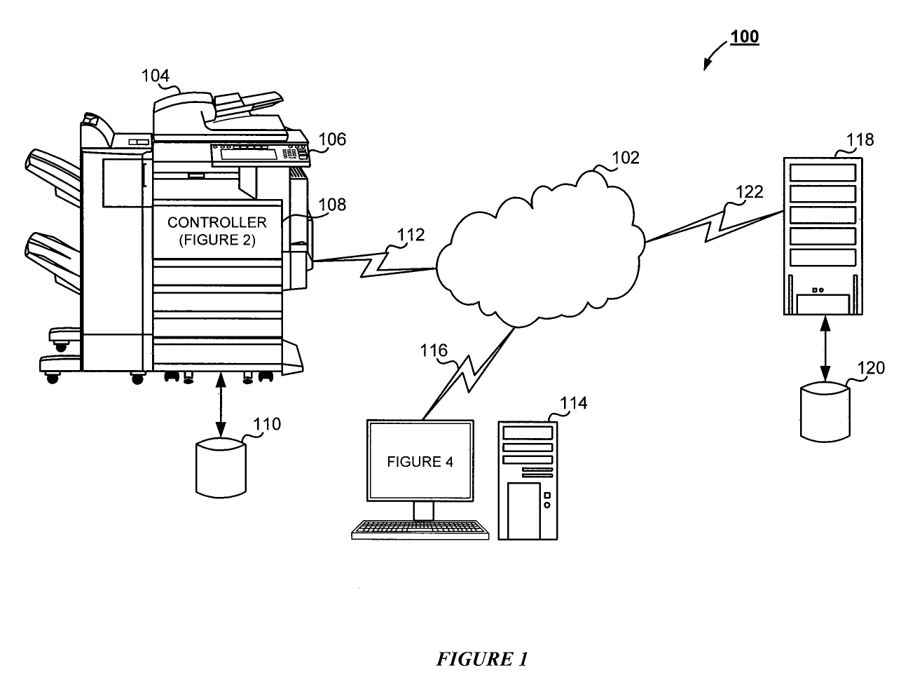

The subject application is directed to a system and method for addressing fixes for problems in a plurality of document processing devices. In particular, the subject application is directed to a system and method for prescreening of vulnerability risks and generation of text-based messages that are prepared and distributed to plural networked machines, and which messages dictate procedures to be taken to address such vulnerability risks. More particularly, the subject application is directed to a system and method for automated distribution and implementation of security fixes. It will become apparent to those skilled in the art that the system and method described herein are suitably adapted to a plurality of varying electronic fields employing automated updates including, for example and without limitation, communications, general computing, data processing, document processing, or the like. The preferred embodiment, as depicted in FIG. 1, illustrates a document processing field for example purposes only and is not a limitation of the subject application solely to such a field.

Referring now to FIG. 1, there is shown an overall diagram of a system 100 for automated distribution and implementation of security fixes in accordance with one embodiment of the subject application. As shown in FIG. 1, the system 100 is capable of implementation using a distributed computing environment, illustrated as a computer network 102. It will be appreciated by those skilled in the art that the computer network 102 is any distributed communications system known in the art capable of enabling the exchange of data between two or more electronic devices. The skilled artisan will further appreciate that the computer network 102 includes, for example and without limitation, a virtual local area network, a wide area network, a personal area network, a local area network, the Internet, an intranet, or the any suitable combination thereof. In accordance with the preferred embodiment of the subject application, the computer network 102 is comprised of physical layers and transport layers, as illustrated by the myriad of conventional data transport mechanisms, such as, for example and without limitation, Token-Ring, 802.11(x), Ethernet, or other wireless or wire-based data communication mechanisms. The skilled artisan will appreciate that while a computer network 102 is shown in FIG. 1, the subject application is equally capable of use in a stand-alone system, as will be known in the art.

The system 100 also includes a document processing device 104, depicted in FIG. 1 as a multifunction peripheral device, suitably adapted to perform a variety of document processing operations. It will be appreciated by those skilled in the art that such document processing operations include, for example and without limitation, facsimile, scanning, copying, printing, electronic mail, document management, document storage, or the like. Suitable commercially available document processing devices include, for example and without limitation, the Toshiba e-Studio Series Controller. In accordance with one aspect of the subject application, the document processing device 104 is suitably adapted to provide remote document processing services to external or network devices. Preferably, the document processing device 104 includes hardware, software, and any suitable combination thereof, configured to interact with an associated user, a networked device, or the like.

According to one embodiment of the subject application, the document processing device 104 is suitably equipped to receive a plurality of portable storage media, including, without limitation, Firewire drive, USB drive, SD, MMC, XD, Compact Flash, Memory Stick, and the like. In the preferred embodiment of the subject application, the document processing device 104 further includes an associated user interface 106, such as a touch-screen, LCD display, touch-panel, alpha-numeric keypad, or the like, via which an associated user is able to interact directly with the document processing device 104. In accordance with the preferred embodiment of the subject application, the user interface 106 is advantageously used to communicate information to the associated user and receive selections from the associated user. The skilled artisan will appreciate that the user interface 106 comprises various components suitably adapted to present data to the associated user, as are known in the art. In accordance with one embodiment of the subject application, the user interface 106 comprises a display suitably adapted to display one or more graphical elements, text data, images, or the like to an associated user, receive input from the associated user, and communicate the same to a backend component such as a controller 108, as explained in greater detail below. Preferably, the document processing device 104 is communicatively coupled to the computer network 102 via a suitable communications link 112. As will be understood by those skilled in the art, suitable communications links include, for example and without limitation, WiMax, 802.11a, 802.11b, 802.11g, 802.11(x), Bluetooth, the public switched telephone network, a proprietary communications network, infrared, optical, or any other suitable wired or wireless data transmission communications known in the art.

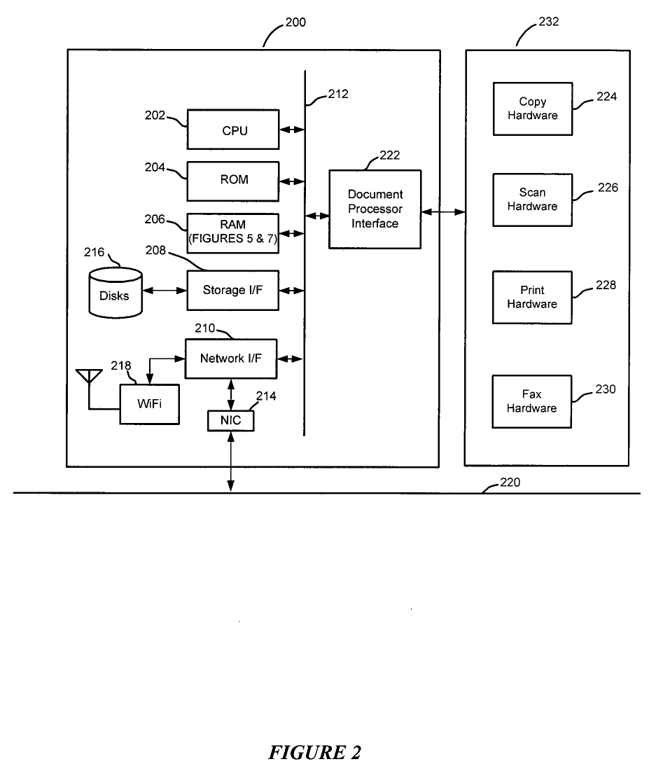

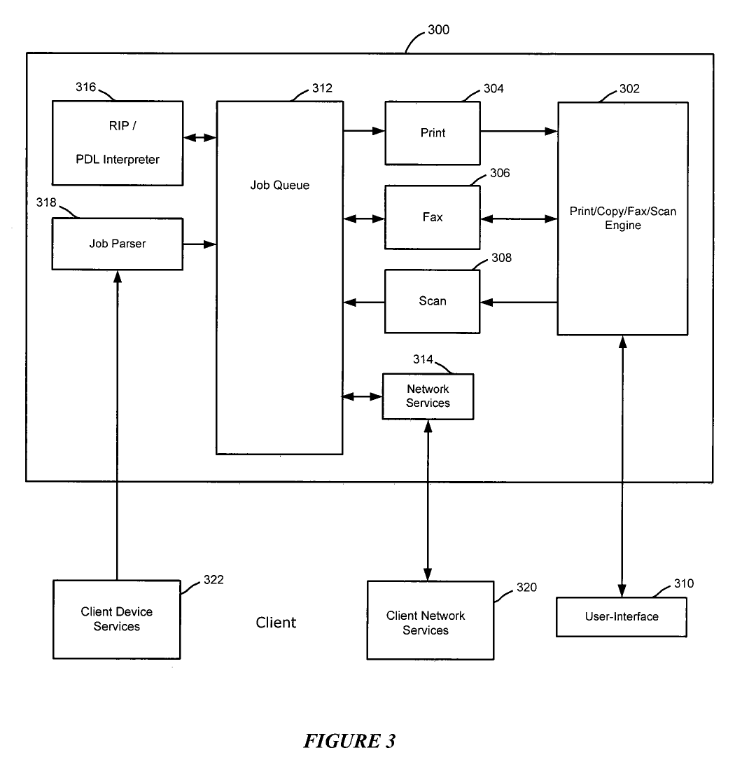

In accordance with one embodiment of the subject application, the document processing device 104 further incorporates a backend component, designated as the controller 108, suitably adapted to facilitate the operations of the document processing device 104, as will be understood by those skilled in the art. Preferably, the controller 108 is embodied as hardware, software, or any suitable combination thereof configured to control the operations of the associated document processing device 104, facilitate the display of images via the user interface 106, direct the manipulation of electronic image data, and the like. For purposes of explanation, the controller 108 is used to refer to any myriad of components associated with the document processing device 104, including hardware, software, or combinations thereof functioning to perform, cause to be performed, control, or otherwise direct the methodologies described hereinafter. It will be understood by those skilled in the art that the methodologies described with respect to the controller 108 are capable of being performed by any general purpose computing system known in the art and, thus, the controller 108 is representative of such a general computing device and is intended as such when used hereinafter. Furthermore, the use of the controller 108 hereinafter is for the example embodiment only, and other embodiments, as will be apparent to one skilled in the art, are capable of employing the system and method for automated distribution and implementation of security fixes of the subject application. The functioning of the controller 108 will better be understood in conjunction with the block diagrams illustrated in FIGS. 2 and 3, explained in greater detail below.

Communicatively coupled to the document processing device 104 is a data storage device 110. In accordance with the preferred embodiment of the subject application, the data storage device 110 is any mass storage device known in the art including, for example and without limitation, magnetic storage drives, a hard disk drive, optical storage devices, flash memory devices, or any suitable combination thereof. In the preferred embodiment, the data storage device 110 is suitably adapted to store document data, image data, electronic database data, or the like. It will be appreciated by those skilled in the art that, while illustrated in FIG. 1 as being a separate component of the system 100, the data storage device 110 is capable of being implemented as internal storage component of the document processing device 104, a component of the controller 108, or the like, such as, for example and without limitation, an internal hard disk drive or the like.

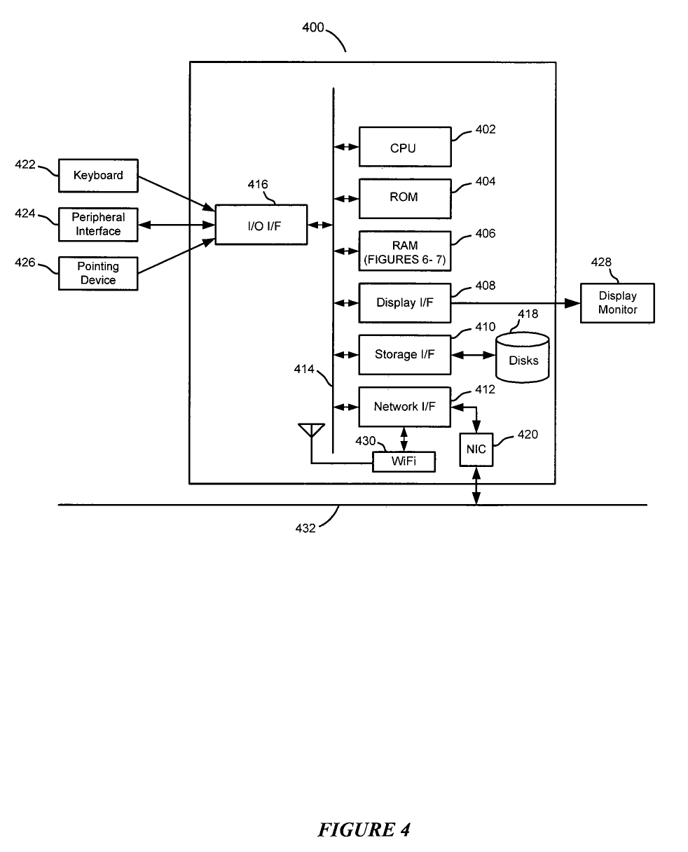

The system 100 illustrated in FIG. 1 further depicts an administrative device 114 in data communication with the computer network 102 via a communications link 116. It will be appreciated by those skilled in the art that the administrative device 114 is shown in FIG. 1 as a computer workstation for illustration purposes only. As will be understood by those skilled in the art, the administrative device 114 is representative of any personal computing device known in the art, including, for example and without limitation, a laptop computer, a personal computer, a personal data assistant, a web-enabled cellular telephone, a smart phone, a proprietary network device, or other web-enabled electronic device. The communications link 116 is any suitable channel of data communications known in the art including, but not limited to, wireless communications, for example and without limitation, Bluetooth, WiMax, 802.11a, 802.11b, 802.11g, 802.11(x), a proprietary communications network, infrared, optical, the public switched telephone network, or any suitable wireless data transmission system, or wired communications known in the art. Preferably, the administrative device 114 is suitably adapted to generate and transmit document processing instructions, security alerts, remedy data, fix data, user interface modifications, upgrades, updates, personalization data, or the like to the document processing device 104 or any other similar device coupled to the computer network 102. The functioning of the administrative device 114 will be better understood in conjunction with the block diagrams illustrated in FIG. 4, explained in greater detail below.

The system 100 of FIG. 1 also includes a third-party system, illustrated by a third-party server 118 and associated data storage device 120 communicatively coupled to the computer network 102 via a communications link 122. It will be appreciated by those skilled in the art that the third-party server 118 comprises hardware, software, and combinations thereof suitably adapted to provide one or more services, web-base applications, storage options, security warnings, vulnerability data, suggested solutions, and the like to networked devices. In accordance with one embodiment of the subject application, the third-party server 118 includes various components implemented as hardware, software, or a combination thereof for the generating of security warnings and updates to users of operating systems supported by the third-party server 118, e.g. MICROSOFT WINDOWS-based operating systems, RED HAT LINUX-based operating systems, and the like. Thus, as the skilled artisan will appreciate, the third-party server 118 corresponds to an operating system manufacturer, supporter, distributor, and the like, which supplies such data to requesting devices via the computer network 102. The communications link 122 is any suitable data communications means known in the art including, but not limited to, wireless communications, for example and without limitation, Bluetooth, WiMax, 802.11a, 802.11b, 802.11g, 802.11(x), a proprietary communications network, infrared, optical, the public switched telephone network, or any suitable wireless data transmission system or wired communications known in the art. It will be appreciated by those skilled in the art that the components for supplying security warnings and solutions described with respect to the third-party server 118 hereinafter are capable of implementation on any computing device coupled to the computer network 102 and functioning in such a role.

Communicatively coupled to the third-party server 118 is the data storage device 120. In accordance with the preferred embodiment of the subject application, the data storage device 120 is any mass storage device known in the art including, for example and without limitation, magnetic storage drives, a hard disk drive, optical storage devices, flash memory devices, or any suitable combination thereof. In the preferred embodiment, the data storage device 120 is suitably adapted to store software updates, update lists, electronic database data, security warnings, vulnerability data, or the like. It will be appreciated by those skilled in the art that, while illustrated in FIG. 1 as being a separate component of the system 100, the data storage device 120 is capable of being implemented as internal storage component of the third-party server 118 or the like, such as, for example and without limitation, an internal hard disk drive or the like.

Turning now to FIG. 2, illustrated is a representative architecture of a suitable backend component, i.e., the controller 200, shown in FIG. 1 as the controller 108, on which operations of the subject system 100 are completed. The skilled artisan will understand that the controller 108 is representative of any general computing device known in the art that is capable of facilitating the methodologies described herein. Included is a processor 202 suitably comprised of a central processor unit. However, it will be appreciated that the processor 202 may advantageously be composed of multiple processors working in concert with one another, as will be appreciated by one of ordinary skill in the art. Also included is a non-volatile or read only memory 204, which is advantageously used for static or fixed data or instructions such as BIOS functions, system functions, system configuration data, and other routines or data used for operation of the controller 200.

Also included in the controller 200 is random access memory 206, suitably formed of dynamic random access memory, static random access memory, or any other suitable addressable and writable memory system. Random access memory 206 provides a storage area for data instructions associated with applications and data handling accomplished by the processor 202.

A storage interface 208 suitably provides a mechanism for non-volatile, bulk or long term storage of data associated with the controller 200. The storage interface 208 suitably uses bulk storage, such as any suitable addressable or serial storage such as a disk, optical, tape drive, and the like, as shown as 216, as well as any suitable storage medium, as will be appreciated by one of ordinary skill in the art.

A network interface subsystem 210 suitably routes input and output from an associated network allowing the controller 200 to communicate to other devices. The network interface subsystem 210 suitably interfaces with one or more connections with external devices to the controller 200. By way of example, illustrated is at least one network interface card 214 for data communication with fixed or wired networks, such as Ethernet, token ring, and the like, and a wireless interface 218 suitably adapted for wireless communication via means such as WiFi, WiMax, wireless modem, cellular network, or any suitable wireless communication system. It is to be appreciated, however, that the network interface subsystem suitably utilizes any physical or non-physical data transfer layer or protocol layer, as will be appreciated by one of ordinary skill in the art. In the illustration, the network interface 214 is interconnected for data interchange via a physical network 220 suitably comprised of a local area network, wide area network, or a combination thereof.

Data communication between the processor 202, read only memory 204, random access memory 206, storage interface 208, and the network interface subsystem 210 is suitably accomplished via a bus data transfer mechanism, such as illustrated by bus 212.

Also in data communication with the bus 212 is a document processor interface 222. The document processor interface 222 suitably provides connection with hardware 232 to perform one or more document processing operations. Such operations include copying accomplished via copy hardware 224, scanning accomplished via scan hardware 226, printing accomplished via print hardware 228, and facsimile communication accomplished via facsimile hardware 230. It is to be appreciated that the controller 200 suitably operates any or all of the aforementioned document processing operations. Systems accomplishing more than one document processing operation are commonly referred to as multifunction peripherals or multifunction devices.

Functionality of the subject system 100 is accomplished on a suitable document processing device, such as the document processing device 104, which includes the controller 200 of FIG. 2 (shown in FIG. 1 as the controller 108) as an intelligent subsystem associated with a document processing device. In the illustration of FIG. 3, controller function 300 in the preferred embodiment includes a document processing engine 302. A suitable controller functionality is that incorporated into the Toshiba e-Studio system in the preferred embodiment. FIG. 3 illustrates suitable functionality of the hardware of FIG. 2 in connection with software and operating system functionality as will be appreciated by one of ordinary skill in the art.

In the preferred embodiment, the engine 302 allows for printing operations, copy operations, facsimile operations, and scanning operations. This functionality is frequently associated with multi-function peripherals, which have become a document processing peripheral of choice in the industry. It will be appreciated, however, that the subject controller does not have to have all such capabilities. Controllers are also advantageously employed in dedicated or more limited purposes document processing devices that are subset of the document processing operations listed above.

The engine 302 is suitably interfaced to a user interface panel 310, which panel 310 allows for a user or administrator to access functionality controlled by the engine 302. Access is suitably enabled via an interface local to the controller or remotely via a remote thin or thick client.

The engine 302 is in data communication with print function 304, facsimile function 306, and scan function 308. These functions facilitate the actual operation of printing, facsimile transmission and reception, and document scanning for use in securing document images for copying or generating electronic versions.

A job queue 312 is suitably in data communication with the print function 304, facsimile function 306, and scan function 308. It will be appreciated that various image forms, such as bit map, page description language or vector format, and the like, are suitably relayed from the scan function 308 for subsequent handling via the job queue 312.

The job queue 312 is also in data communication with network services 314. In a preferred embodiment, job control, status data, or electronic document data is exchanged between the job queue 312 and the network services 314. Thus, suitable interface is provided for network-based access to the controller function 300 via client side network services 320, which is any suitable thin or thick client. In the preferred embodiment, the web services access is suitably accomplished via a hypertext transfer protocol, file transfer protocol, uniform data diagram protocol, or any other suitable exchange mechanism. The network services 314 also advantageously supplies data interchange with client side services 320 for communication via FTP, electronic mail, TELNET, or the like. Thus, the controller function 300 facilitates output or receipt of electronic document and user information via various network access mechanisms.

The job queue 312 is also advantageously placed in data communication with an image processor 316. The image processor 316 is suitably a raster image process, page description language interpreter, or any suitable mechanism for interchange of an electronic document to a format better suited for interchange with device functions such as print 304, facsimile 306, or scan 308.

Finally, the job queue 312 is in data communication with a job parser 318, which job parser 318 suitably functions to receive print job language files from an external device, such as client device services 322. The client device services 322 suitably include printing, facsimile transmission, or other suitable input of an electronic document for which handling by the controller function 300 is advantageous. The job parser 318 functions to interpret a received electronic document file and relay it to the job queue 312 for handling in connection with the afore-described functionality and components.

Turning now to FIG. 4, illustrated is a hardware diagram of a suitable workstation 400, illustrated in FIG. 1 as the administrative device 114, for use in connection with the subject system. A suitable administrative device 114, e.g. the workstation 400 of FIG. 4, includes a processor unit 402, which is advantageously placed in data communication with read only memory 404, suitably non-volatile read only memory, volatile read only memory, or a combination thereof; random access memory 406; display interface 408; storage interface 410; and network interface 412. In a preferred embodiment, interface to the foregoing modules is suitably accomplished via a bus 414.

The read only memory 404 suitably includes firmware, such as static data or fixed instructions such as BIOS, system functions, configuration data, and other routines used for operation of the workstation 400 via CPU 402.

The random access memory 406 provides a storage area for data and instructions associated with applications and data handling accomplished by the processor 402.

The display interface 408 receives data or instructions from other components on the bus 414, which data is specific to generating a display to facilitate a user interface. The display interface 408 suitably provides output to a display terminal 428, suitably a video display device such as a monitor, LCD, plasma, or any other suitable visual output device, as will be appreciated by one of ordinary skill in the art.

The storage interface 410 suitably provides a mechanism for non-volatile, bulk or long term storage of data or instructions in the workstation 400. The storage interface 410 suitably uses a storage mechanism, such as storage 418, suitably comprised of a disk, tape, CD, DVD, or other relatively higher capacity addressable or serial storage medium.

The network interface 412 suitably communicates to at least one other network interface, shown as network interface 420, such as a network interface card, and wireless network interface 430, such as a WiFi wireless network card. It will be appreciated by one of ordinary skill in the art that a suitable network interface is comprised of both physical and protocol layers and is suitably any wired system, such as Ethernet, token ring, or any other wide area or local area network communication system, or any wireless system, such as WiFi, WiMax, or any other suitable wireless network system. In the illustration, the network interface 420 is interconnected for data interchange via a physical network 432 suitably comprised of a local area network, wide area network, or a combination thereof.

An input/output interface 416 in data communication with the bus 414 is suitably connected with an input device 422, such as a keyboard or the like. The input/output interface 416 also suitably provides data output to a peripheral interface 424 such as a USB, universal serial bus output, SCSI, Firewire (IEEE 1394) output, or any other interface, as may be appropriate for a selected application. Finally, the input/output interface 416 is suitably in data communication with a pointing device interface 426 for connection with devices such as a mouse, light pen, touch screen, or the like.

In operation, a text message is received into a data storage of a document processing device via an associated data network. Strings in the received text message are then parsed so as to isolate control data. Preferably, the control data includes advisory data corresponding to the applicability of a security risk associated with a class of devices and also includes remedy data corresponding to a solution to a vulnerability problem associated with vulnerability data. The advisory data is then tested for applicability to the document processing device, and the remedy data is then analyzed in accordance with the output of the advisory test. An alteration of the document processing device is then completed in accordance with the output of analysis. The acceptability of the alteration of the document processing device is then verified. An applied alteration of the document processing device is then undone in accordance with an output of the verification.

In accordance with one example embodiment of the subject application, warning data associated with a risk associated with hardware and/or software of a class of devices is first received. The received warning data is then tested relative to data associated with hardware and/or software associated with the class of devices. Fix data is then generated in accordance with the received warning data corresponding to a fix associated with the class of devices. A text message is then selectively generated based upon the testing output. The generated fix data is thereafter communicated to a plurality of devices in the class of devices via an associated data network.

In accordance with another example embodiment of the subject application, a security warning, such as an exploit in an operating system, application software, or the like, is received by the administrative device 114 from the third-party server 118. The skilled artisan will appreciate that such a warning suitably addresses a discovered or known exploit in software supported by the third-party server 118 and operative on an associated document processing device 104. Thus, as shown in FIG. 1, the document processing device 104, via the controller 108 or other suitable component associated therewith, operates software supported by the third-party associated with the server 118.

Upon receipt by the administrative device 114 of the security warning from the server 118, the administrative device 114 first determines the class of devices affected by the vulnerability, exploit, update, upgrade, or the like. Once the class of devices has been determined by the administrative device 114, the devices on the network 102 are analyzed to determine whether any devices in the class are present. For example, the security warning issued by the third-party server 118 is capable of corresponding to a mobile operating system, such as WINDOWS-MOBILE by the MICROSOFT CORPORATION, such that no affected device is present on the network 102.

Following a determination that at least one device, e.g. the document processing device 104, is present on the network 102 and affected by the warning, based upon the class in which the device 104 resides, the risk level associated with the security warning is analyzed. Preferably, the analysis performed by the administrative device 114 on the security warning corresponds to determining whether or not the level of the risk exceeds a predetermined threshold level. The skilled artisan will appreciate that certain security risks or vulnerabilities are capable of having varying levels of risk, e.g. high risk, medium risk, low risk, or the like. With such levels, the skilled artisan will further appreciate that varying actions are instituted dependent upon the level of the risk. Thus, if the risk or vulnerability corresponds to a high or medium risk level, some action on the part of the administrative device 114 is warranted, whereas low risk level warnings may not require such actions. In accordance with one embodiment of the subject application, a warning of an exploit in an operating system would correspond to a high-level risk, thus exceeding a predetermined threshold level, while an update, e.g. a driver update, font update, or the like, would correspond to a low-level risk, whereupon automated updating of a fix to the risk is not necessary.

When the determined risk level exceeds the predetermined threshold level, the administrative device 114 generates advisory and remedy data corresponding to the received warning from the server 118. According to one embodiment of the subject application, the administrative device 114 generates fix data corresponding to a fix associated with the class of devices in accordance with the received security warning. A text message is then generated by the administrative device 114, including advisory data representing the received security warning and remedy data representing a fix or solution associated with the security warning. In accordance with one embodiment of the subject application, the text message also includes timing data corresponding to a time in which to implement the remedy data, e.g. low-usage time of the document processing device 104, weekends, or the like.

The administrative device 114 then identifies those devices on the network 102 in the determined class of devices, e.g. the document processing device 104. According to one embodiment of the subject application, the identification of those devices on the computer network 102 in the determined class of devices corresponds to a mailing list of such devices, e.g. a listing of IP addresses, electronic mail addresses, or the like, with each address corresponding to a device within the class of devices. Thereafter, the administrative device 114, via the computer network 102, communicates the text message to the identified devices. The skilled artisan will appreciate that any suitable protocol for communicating the generated message to the identified devices is capable of being used including, for example and without limitation, facsimile, HTTP, HTTPS, FTP, SOAP, XML, web services, RPC, RMI, DCOM, and the like. In addition, those skilled in the art will further appreciate that the administrative device 114 is capable of communicating the message via direct (unicast), broadcast, multicast, or other such transmission.

The message is then received by the controller 108 or other suitable component associated with the document processing device 104 and stored in a suitable queue, as will be understood by those skilled in the art. The message remains in the queue until such time as the timing data indicates processing of the message is to be undertaken, e.g. a high-level warning is capable of indicating immediate processing, whereas a medium or low-level warning indicates processing at a time when device 104 resources are not in use. When the timing data indicates processing is to be undertaken, the message is parsed to isolate advisory data and remedy data from the message. The advisory data is then analyzed by the controller 108 or other suitable component associated with the document processing device 104 to determine whether the advisory affects, i.e. is applicable to, the receiving document processing device 104.

When it is determined that the advisory, i.e. the warning, applies to hardware, software, or any combination thereof associated with the document processing device 104, the remedy data is analyzed to determine whether a patch is available to alleviate the warning, e.g. fix the security issue. When a patch is not available, e.g. the administrative device 114 has generated fix data to fix the security issue, the controller 108 or other suitable component associated with the document processing device 104 applies the remedy as designated by the received message. Thereafter, the alterations to the document processing device 104 are verified to ascertain whether the changes, e.g. the application of the fix data, is acceptable and does not adversely affect the operations of the document processing device 104. When a problem is detected, the controller 108 or other suitable component associated with the document processing device 104 undoes the application of the remedy data, e.g. “rolls” the device 104 back to its pre-remedy state.

When the remedy data, as analyzed by the controller 108 or other suitable component associated with the document processing device 104, indicates that a software patch is available for rectifying the security issue, the appropriate software patch is then retrieved from the administrative device 114, the server 118, or the like. The patch is then applied and verified. Upon successful verification of the application of the software patch, the document processing device 104 continues processing operations. It will be appreciated by those skilled in the art that some patches are capable of requiring a restart of the document processing device 104 and, in such circumstances, the device 104 restarts prior to the verification of the installation of the retrieved software patch. When verification is not successful, the controller 108 or other suitable component associated with the document processing device 104 undoes the application of the software patch, thereby returning the document processing device 104 to its pre-patch state.

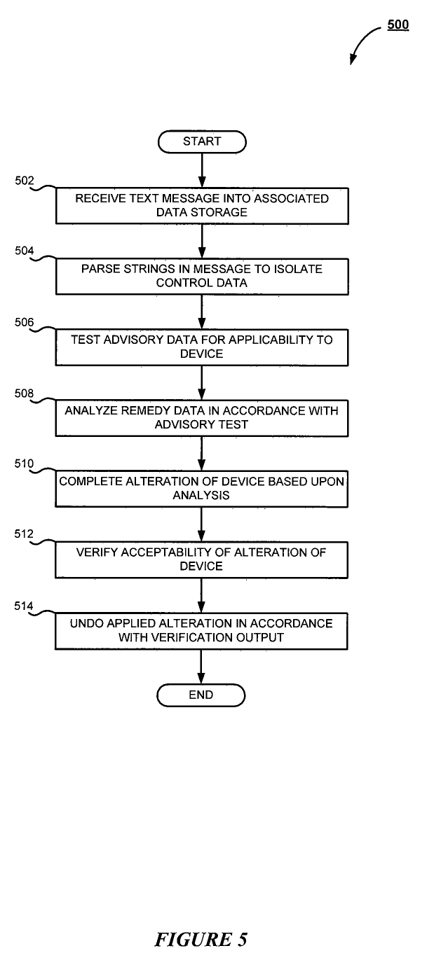

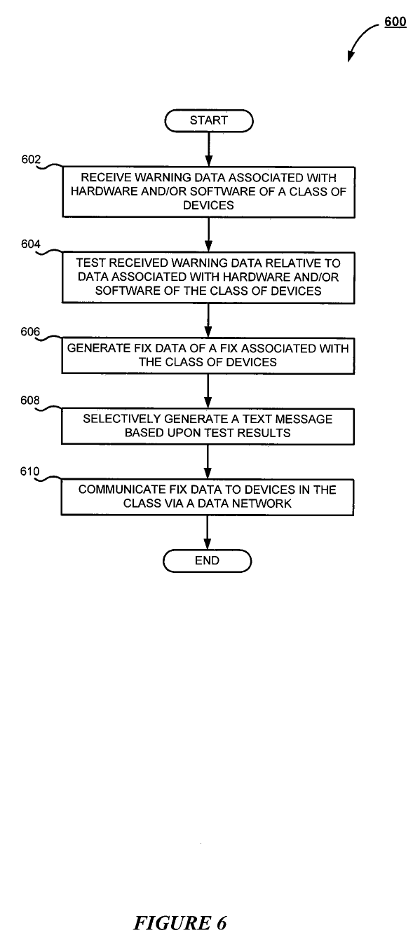

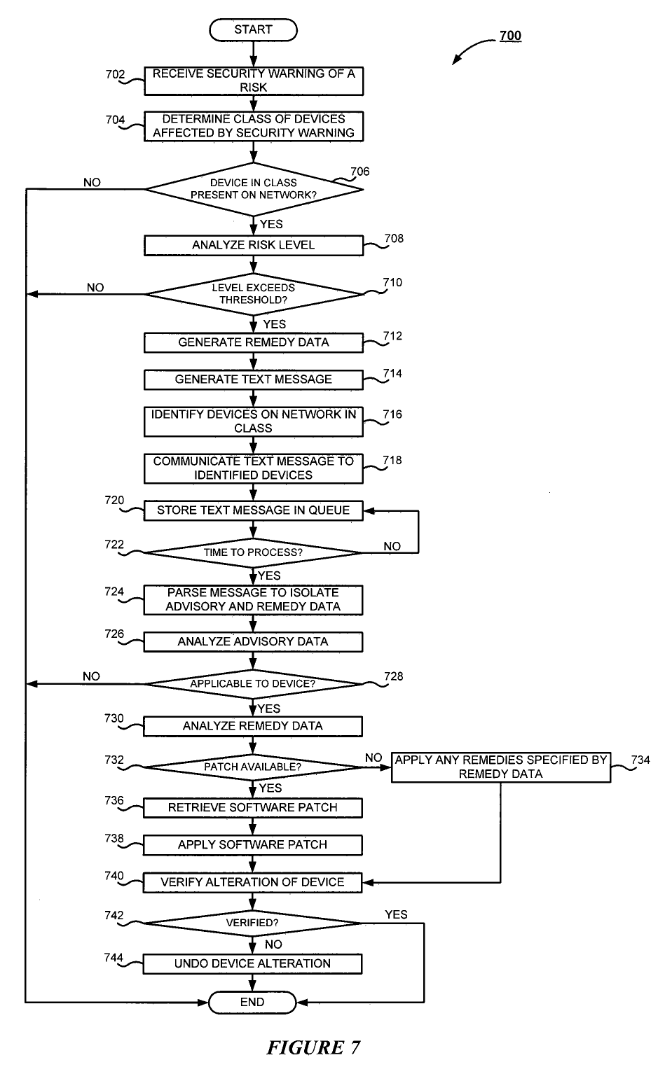

The skilled artisan will appreciate that the subject system 100 and components described above with respect to FIG. 1, FIG. 2, FIG. 3, and FIG. 4 will be better understood in conjunction with the methodologies described hereinafter with respect to FIG. 5, FIG. 6, and FIG. 7. Turning now to FIG. 5, there is shown a flowchart 500 illustrating a method for automated distribution and implementation of security fixes in accordance with one embodiment of the subject application. Beginning at step 502, the controller 108 or other suitable component associated with the document processing device 104 receives a text message from the administrative device 114 via the computer network 102.

The received text message is then parsed, at step 504, so as to isolate control data, which includes advisory data corresponding to the applicability of a security risk associated with a class of devices and remedy data corresponding to a solution to a vulnerability problem associated with vulnerability data, e.g. the security risk. Preferably, the controller 108 parses the received text message to determine the security risk and any remedies identified by the administrative device 114. The controller 108 or other suitable component associated with the document processing device 104 then tests the advisory data for applicability to the document processing device 104 at step 506. That is, the controller 108 determines whether the document processing device 104 belongs to the class of devices to which the security risk is applicable in accordance with the received advisory data.

The remedy data is then analyzed at step 508 based upon the output of the advisory test. Stated another way, the remedy data is analyzed upon a determination by the controller 108 that the security risk is applicable to the associated document processing device 104, as determined via the testing of the advisory data. At step 510, alteration of the document processing device 104 is completed in accordance with the analysis of the remedy data. Preferably, the controller 108 or other suitable component associated with the document processing device 104 implements the fixes, patches, updates, or the like, as indicated by the received remedy data.

The acceptability of the alteration of the document processing device 104 is then verified at step 512 by the controller 108 or other suitable component associated with the document processing device 104. At step 514, the application of the alteration to the document processing device 104 is undone in accordance with the output of the verification performed at step 514. The skilled artisan will appreciate that the controller 108 or other suitable component associated with the document processing device 104 is capable of analyzing the application of the remedy to determine whether the functioning of the document processing device 104 is impaired as a result thereof. Upon such a determination, the controller 108 or other suitable component associated with the document processing device 104 removes the applied remedy, thereby restoring the document processing device 104 to its previous operating state.

Referring now to FIG. 6, there is shown a flowchart 600 illustrating a method for automated distribution and implementation of security fixes in accordance with one embodiment of the subject application. The methodology depicted in FIG. 6 begins at step 602, whereupon the administrative device 114 receives warning data from the server 118 corresponding to a security risk associated with hardware and/or software of a class of devices. The administrative device 114 then tests, at step 604, the received warning data relative to data associated with the hardware and/or software associated with the class of devices. That is, the administrative device 114 determines whether the risk corresponds to a hardware vulnerability, a software vulnerability, a risk level, update, or the like.

At step 606, the administrative device 114 generates fix data corresponding to a fix associated with the class of devices to which the received warning data applies. The administrative device 114 then selectively generates, at step 608, a text message based upon the output of the test performed on the received warning data. Using the computer network 102, the administrative device 114 communicates the generated text message to the devices in the class of devices at step 610.

Turning now to FIG. 7, there is shown a flowchart 700 illustrating a method for automated distribution and implementation of security fixes in accordance with one embodiment of the subject application. As shown in FIG. 7, the methodology begins at step 702, whereupon the administrative device 114 receives a security warning, such as an exploit in an operating system, application software, or the like, from the third-party server 118. It will be appreciated by those skilled in the art that such a warning suitably addresses a discovered or known exploit/issue/security risk in hardware and/or software that is supported by the third-party server 118 and that is operative on the associated document processing device 104.

At step 704, the administrative device 114 determines the class of devices affected by the security warning received from the third-party server 118. Once the class of devices affected by the vulnerability, exploit, update, upgrade, or the like, has been identified, a determination is made by the administrative device 114 as to whether at least one device in the class of devices is present on the computer network 102 at step 706. For example, the security warning issued by the third-party server 118 is capable of corresponding to a LINUX-based operating system, such as that provided by RED HAT, and the only device in the network 102 is a WINDOWS-based document processing device 104, such that no affected device is present on the network 102. Upon such a determination that no device in the identified class is present on the computer network 102, the administrative device 114 takes no action with respect to the received security warning, and the methodology of FIG. 7 terminates.

Upon a determination at step 706 that at least one device, for example the document processing device 104, is present on the network 102, flow proceeds to step 708. At step 708, the administrative device 114 analyzes the risk level associated with the received security warning. A determination is then made at step 710 whether or not the level of the risk, as analyzed, exceeds a predetermined threshold level. In accordance with one embodiment of the subject application, the skilled artisan will appreciate that security risks or vulnerabilities have varying levels of risk, e.g. high risk, medium risk, and low risk, with corresponding actions instituted in response to the level of risk associated with the warning. For example, an exploit that allows unauthorized remote access to a device corresponds to a high or medium risk level. In accordance with one embodiment of the subject application, a warning of an exploit in an operating system would correspond to a high-level risk, thus exceeding a predetermined threshold level, while an update, e.g. a driver update, font update, or the like, would correspond to a low-level risk, whereupon automated updating of a fix to the risk is not necessary. When the risk level does not exceed the predetermined threshold, the administrative device 114 takes no action with respect to the received warning and the methodology of FIG. 7 terminates.

When it is determined at step 710 that the risk level exceeds the predetermined threshold level, flow proceeds to step 712. At step 712, the administrative device 114 generates advisory and remedy data corresponding to the warning received from the server 118. In accordance with one embodiment of the subject application, fix data is generated by the administrative device 114 corresponding to a fix associated with the class of devices in accordance with the received security warning, which is then indicated in the remedy data as an available solution to the security issue. The administrative device 114 then generates a text message at step 714 that includes advisory data corresponding to the received security warning and remedy data corresponding to an available fix (fix data), available software patch, or other suitable solution associated with the security warning. Preferably, the text message also includes timing data indicative of a time in which the document processing device 104 is to implement the remedy data, e.g. low-usage time of the document processing device 104, weekends, or the like.

At step 716, the administrative device 114 identifies those devices on the network 102 in the determined class of devices, e.g. the document processing device 104. In accordance with one particular embodiment of the subject application, the identification of those devices in the class on the computer network 102 corresponds to a mailing list of such devices, which is inclusive of address data. Suitable addresses include, for example and without limitation, IP addresses, electronic mail addresses, facsimile numbers, and the like. It will be understood by those skilled in the art that each address in the mailing list of devices corresponds to an individual device within the class of devices.

The administrative device 114 then communicates the text message to the identified devices via the computer network at step 718. It will be appreciated by those skilled in the art that any suitable protocol for communicating the generated message to the identified devices is capable of being used including, for example and without limitation, facsimile, HTTP, HTTPS, FTP, SOAP, XML, web services, RPC, RMI, DCOM, and the like. In addition, the skilled artisan will further appreciate that the administrative device 114 is capable of communicating the message via direct (unicast), broadcast, multicast, or other such transmission.

The message is then received by the controller 108 or other suitable component associated with the document processing device 104 and stored in a suitable processing queue at step 720. A determination is made at step 722 as to whether it is time for the controller 108 or other suitable component associated with the document processing device 104 to process the received text message. That is, the text message remains in the queue until such time as the timing data indicates processing of the message is to be undertaken, e.g. a high-level warning is capable of indicating immediate processing, whereas a medium or low-level warning indicates processing at a time when device 104 resources are not in use. A negative determination at step 722 returns to the storage of the message in the queue at step 720 until the timing data indicates processing of the message is warranted.

Upon a positive determination at step 722, flow proceeds to step 724, whereupon the controller 108 or other suitable component associated with the document processing device 104 parses the received message so as to isolate control data in the form of the advisory data and the remedy data. The controller 108 or other suitable component associated with the document processing device 104 then analyzes the advisory data at step 726. A determination is then made at step 728 to determine whether the advisory affects, i.e. is applicable to, the receiving document processing device 104.

When it is determined at step 728 that the security advisory does not apply to hardware, software, or any combination thereof associated with the document processing device 104, the administrative device 114 takes no action with respect to the advisory data, and the methodology of FIG. 7 terminates. Upon a positive determination at step 728, flow proceeds to step 730. At step 730, the controller 108 or other suitable component associated with the document processing device 104 analyzes the remedy data. Based upon this analysis, a determination is made at step 732 whether a patch is available to fix the security issue. Upon a determination at step 732 that no patch is available, flow progresses to step 734, whereupon the controller 108 or other suitable component associated with the document processing device 104 applies the remedy as designated by the received message. For example, when the administrative device 114 has generated fix data corresponding to a remedy to the security issue, the fix data is applied at step 734. The alterations to the document processing device 104 are then verified at step 740 and a determination is made at step 742 whether the application of the fix data has been verified. Upon a determination that the application of the fix data has not been verified, flow proceeds to step 744, whereupon the alteration of the device 104 is undone. That is, the controller 108 or other suitable component associated with the document processing device 104 undoes the application of the remedy data, e.g. “rolls” the device 104 back to its pre-remedy state.

Returning to step 732, upon a determination that a software patch is available, based upon the analysis of the remedy data by the controller 108 or other suitable component associated with the document processing device 104, flow proceeds to step 736. At step 736, the controller 108 or other suitable component associated with the document processing device 104 retrieves the appropriate software patch from the administrative device 114, the server 118, or the like. The patch is then applied to the document processing device 104 at step 738. Verification of the application of the retrieved software patch is then performed by the controller 108 or other suitable component associated with the document processing device 104 at step 740. A determination is then made at step 742 whether or not the application of the retrieved software patch has been successfully verified. Upon successful verification of the application of the software patch, the document processing device 104 continues processing operations. It will be appreciated by those skilled in the art that some patches are capable of requiring a restart of the document processing device 104 and, in such circumstances, the device 104 restarts prior to the verification of the installation of the retrieved software patch. Upon a determination at step 742 that the verification of the application of the patch is not successful, the controller 108 or other suitable component associated with the document processing device 104 undoes the application of the software patch at step 744. Thereafter, the document processing device 104 returns to its pre-patch state for document processing operations.

The subject application extends to computer programs in the form of source code, object code, code intermediate sources and partially compiled object code, or in any other form suitable for use in the implementation of the subject application. Computer programs are suitably standalone applications, software components, scripts, or plug-ins to other applications. Computer programs embedding the subject application are advantageously embodied on a carrier, being any entity or device capable of carrying the computer program: for example, a storage medium such as ROM or RAM; optical recording media such as CD-ROM or magnetic recording media such as floppy discs; or any transmissible carrier such as an electrical or optical signal conveyed by electrical or optical cable, radio, or other means. Computer programs are suitably downloaded across the Internet from a server. Computer programs are also capable of being embedded in an integrated circuit. Any and all such embodiments containing code that will cause a computer to perform substantially the subject application principles as described will fall within the scope of the subject application.

The foregoing description of a preferred embodiment of the subject application has been presented for purposes of illustration and description. It is not intended to be exhaustive or to limit the subject application to the precise form disclosed. Obvious modifications or variations are possible in light of the above teachings. The embodiment was chosen and described to provide the best illustration of the principles of the subject application, and its practical application to thereby enable one of ordinary skill in the art to use the subject application in various embodiments and with various modifications as are suited to the particular use contemplated. All such modifications and variations are within the scope of the subject application as determined by the appended claims when interpreted in accordance with the breadth to which they are fairly, legally, and equitably entitled.

What is claimed:

1. A system for automated distribution and implementation of security fixes comprising:
means adapted for receiving a text message into a data storage of a document processing device via an associated data network;
parsing means adapted for parsing strings in a received text message so as to isolate control data, wherein control data includes advisory data corresponding to applicability of a security risk associated with a class of devices and remedy data corresponding to a solution to a vulnerability problem associated with vulnerability data;
testing means adapted for testing advisory data for applicability to the document processing device;
analyzing means adapted for analyzing the remedy data in accordance with an output of the testing means;
updating means adapted for completing an alteration of the document processing device in accordance with an output of the analyzing means;
verification means adapted for verifying acceptability of an alteration of the document processing device in accordance with operation of the updating means; and
means adapted for undoing an applied alteration of the document processing device in accordance with an output of the verification means.

2. The system of claim 1 further comprising:
means adapted for receiving warning data associated with a risk associated with at least one of hardware and software associated with the class of devices;
classification means adapted for testing received warning data relative to data associated with at least one of hardware and software associated with the class of devices;
generating means adapted for generating fix data corresponding to a fix associated with the class of devices in accordance with received warning data;
means adapted for selectively generating the text message in accordance with an output of the classification means; and
output means adapted for communicating generated fix data to a plurality of devices in the class of devices via the associated data network.

3. The system of claim 2 wherein the output means includes means adapted for communicating generated fix data to a plurality of devices in accordance with a mailing list inclusive of address data associated with each of the plurality of devices in the class of devices.

4. The system of 2 further comprising threshold means adapted for testing severity of warning data against at least one pre-selected threshold level, and wherein the generating means includes means adapted for generating fix data upon a determination by the threshold means that the at least one pre-selected threshold level has been achieved.

5. The system of claim 1 further comprising:
means adapted for retrieving a software patch specified by the remedy data in accordance with an output of the analyzing means; and
wherein the updating means further includes means adapted for applying a retrieved software patch.

6. The system of claim 1 wherein the text message further includes timing data associated with a desired timing of an updating by the updating means, and wherein the updating means is further adapted to commence alteration of the document processing device in accordance with received timing data.

7. A method for automated distribution and implementation of security fixes comprising the steps of:
receiving a text message into a data storage of a document processing device via an associated data network;
parsing strings in a received text message so as to isolate control data, wherein control data includes advisory data corresponding to applicability of a security risk associated with a class of devices and remedy data corresponding to a solution to a vulnerability problem associated with vulnerability data;
testing advisory data for applicability to the document processing device;
analyzing the remedy data in accordance with an output of the testing step;
completing an alteration of the document processing device in accordance with an output of the analyzing step;
verifying acceptability of an alteration of the document processing device; and
undoing an applied alteration of the document processing device in accordance with an output of the verification step.

8. The method of claim 7 further comprising the steps of:
receiving warning data associated with a risk associated with at least one of hardware and software associated with the class of devices;
testing received warning data relative to data associated with at least one of hardware and software associated with the class of devices;
generating fix data corresponding to a fix associated with the class of devices in accordance with received warning data;
selectively generating the text message in accordance with an output of the testing step; and
communicating generated fix data to a plurality of devices in the class of devices via the associated data network.

9. The method of claim 8 wherein the communication of generated fix data to a plurality of devices is in accordance with a mailing list inclusive of address data associated with each of the plurality of devices in the class of devices.

10. The method of 8 further comprising the step of testing severity of warning data against at least one pre-selected threshold level, and wherein fix data is generated upon a determination by the threshold means that the at least one pre-selected threshold level has been achieved.

11. The method of claim 7 further comprising the steps of:
retrieving a software patch specified by the remedy data in accordance with an output of the analyzing step; and
applying a retrieved software patch.

12. The method of claim 7 wherein the text message further includes timing data associated with a desired timing of an updating, and wherein the alteration of the document processing device is commenced in accordance with received timing data.
